(19) United States
(12) Patent Application Publication
(10) Pub. No.: US 2026/0138543 A1
(43) Pub. Date: May 21, 2026

(54) FASTENING DEVICE

(71) Applicant: GM Global Technology Operations LLC, Detroit, MI (US)

(72) Inventors: Myungcheol Kim, Incheon (KR); Sanghyun Song, Seoul (KR)

(73) Assignee: GM Global Technology Operations LLC, Detroit, MI (US)

(21) Appl. No.: 18/948,957

(22) Filed: Nov. 15, 2024

(51) Int. Cl. B60R 16/02; F16B 2/20

(52) U.S. Cl. CPC B60R 16/0215; F16B 2/20

(57) ABSTRACT

A fastening device comprising a base. The base comprises a first side and a second side spaced from the first side with respect to a first axis, a third side and fourth side spaced from the third side with respect to a second axis, a top side and a bottom side spaced from the top side with respect to a third axis, the first axis, the second axis, and the third axis being perpendicular to one another, and one or more receptacles arranged between the top side and the bottom side. The fastening device further comprises one or more clips arranged in the one or more receptacles.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to fastening devices and, more particularly, to a fastener for securing a conduit to a vehicle or machine.

Fasteners or clips are commonly used to help secure components, such as brake lines, fuel lines, wire harnesses, etc., to another component or structure, such as a vehicle or machine. These fasteners play a crucial role in maintaining the integrity and functionality of various systems within a vehicle by ensuring that components are securely held in place, preventing damage and ensuring optimal performance. However, the manufacturing of these fasteners requires extensive tooling to accommodate conduits, pipes, tubes, and other components of different shapes and diameters. This complexity in manufacturing limits the flexibility and adaptability of the fasteners to different applications.

Despite the widespread use of these fasteners, existing devices often fall short in addressing the diverse needs of modern vehicle designs. Many current fasteners lack the versatility to securely hold components of varying sizes and shapes without requiring multiple different fasteners, leading to inefficiencies in both manufacturing and application. The present disclosure aims to address these shortcomings.

### SUMMARY

In one configuration, a fastening device is provided and includes a base. The base includes a plate having a first side and a second side spaced from the first side with respect to a first axis, a third side and fourth side spaced from the third side with respect to a second axis, a top side and a bottom side spaced from the top side with respect to a third axis, the first axis, the second axis, and the third axis being perpendicular to one another, and one or more receptacles arranged between the top side and the bottom side. The fastening device further includes one or more clips arranged in the one or more receptacles.

The fastening device may include one or more of the following optional aspects. For example, the one or more receptacles can include a first guide and a second guide spaced from the first guide with respect to the first axis. The first guide can include a first surface facing the second side and the second guide can include a second surface opposing the first surface and facing the first side. The first guide can include a first groove extending between the first surface and the first side with respect to the first axis and between the third side and the fourth side with respect to the second axis and the second guide can include a second groove extending between the second surface and the second side and between the third side and the fourth side with respect to the second axis, the first groove and the second groove defining an opening. The plate can further include a lock arm arranged in the opening between the first guide and the second guide. The lock arm can include a lock that has a drive-on surface facing the third side and a retainer surface facing the fourth side.

According to at least one aspect, the base can further include a fastener having a proximal end and a distal end opposite the proximal end. The proximal end can be coupled to the bottom side of the plate and one or more engagement legs can be coupled to the distal end and extend toward the bottom side of the plate. The fastener can include a flange depending away from the bottom side of the plate and one or more steps arranged on the engagement legs, the one or more steps opposing the flange.

In another configuration, a fastening device is provided and includes a base. The base includes a plate having one or more receptacles and a fastener coupled to the plate. The fastening device includes one or more clips arranged in the one or more receptacles. The one or more clips including a first side and a second side spaced from the first side, a third side and a fourth side spaced from the third side, a top side and a bottom side spaced from the top side, and a cavity that extends between the third side and the fourth side and between the top side and the bottom side.

The fastening device may include one or more of the following optional aspects. For example, the one or more clips may include at least one first clip configured to receive a conduit with a first diameter and one or more additional clips that are configured to receive a conduit with a diameter other than the first diameter.

According to at least one aspect, the one or more clips further include an arm that has a proximal end coupled to the top side and a distal end spaced from the proximal end, the distal end being arranged in the cavity. The arm can be cantilevered with respect to the cavity and includes an engagement surface extending between the proximal end and the distal end.

According to another aspect, the one or more clips can further include a first rail and a second rail coupled to the bottom side, the first rail being arranged parallel to the second rail. The first rail can include a first inner surface and a first outer surface opposite the inner surface. The first rail can include a first track that extends from the first outer surface toward the second side. The second rail can include a second inner surface and a second outer surface opposite the second inner surface. The second rail can include a second track that extends from the second outer surface toward the first side and a latch coupled the second inner surface and extending toward the first inner surface.

In another configuration, a vehicle is provided and includes a vehicle body having a first end and second end spaced from the first end with respect to a longitudinal axis and at least one conduit assembly coupled to the vehicle body and extending between the first end and the second end. The at least one conduit assembly includes one or more fastening devices. The one or more fastening devices includes a base having a plate including a first side and a second side spaced from the first side with respect to a first axis, a third side and fourth side spaced from the third side with respect to a second axis, a top side and a bottom side spaced from the top side with respect to a third axis, the first axis, the second axis, and the third axis being perpendicular to one another, and one or more receptacles arranged between the top side and the bottom side. The at least one fastening device includes one or more clips coupled to the plate. The one or more clips include a first side and a second side spaced from the first side of the one or more clips with respect to the first axis, a third side and a fourth side spaced from the third side of the one or more clips with respect to the second axis, and a top side and a bottom side spaced from the top side of the one or more clips with respect to the third axis.

The vehicle may include one or more of the following optional aspects. For example, the third side of the one or more clips can be arranged flush with the third side of the plate. The fourth side of the one or more clips can be arranged flush with the fourth side of the plate.

According to at least one aspect, the at least one conduit assembly can further include one or more conduits of varying diameter and extending between the first end and the second end of the vehicle body, the one or more conduits being coupled to each conduit assembly. The one or more conduits include at least one of a brake line, a fuel line, and a wire harness.

### BRIEF DESCRIPTION OF THE DRAWINGS

The drawings described herein are for illustrative purposes only of selected configurations and are not intended to limit the scope of the present disclosure.

FIG. 1 is a side view of a vehicle according to principles of the present disclosure;

FIG. 2 is an illustrative example of a conduit assembly including one or more fasteners;

FIG. 3 is a rear perspective view of the one or more fasteners of FIG. 2 including a base and one or more clips;

FIG. 4A is a top perspective view of the base of FIG. 3;

FIG. 4B is a bottom perspective view of the base of FIG. 3;

FIG. 4C is a front view of the base of FIG. 3;

FIG. 4D is a top view of the base of FIG. 3;

FIG. 5A is a rear perspective view of the one or more clips of FIG. 3;

FIG. 5B is a rear view of the one or more clips of FIG. 3;

FIG. 5C is a front view of the one or more clips of FIG. 3;

FIG. 5D is a top view of the one or more clips of FIG. 3;

FIG. 5E is a bottom view of the one or more clips of FIG. 3; and

FIG. 6 is a front view of the fastener of FIG. 3 being arranged in a portion of a vehicle body of the vehicle of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

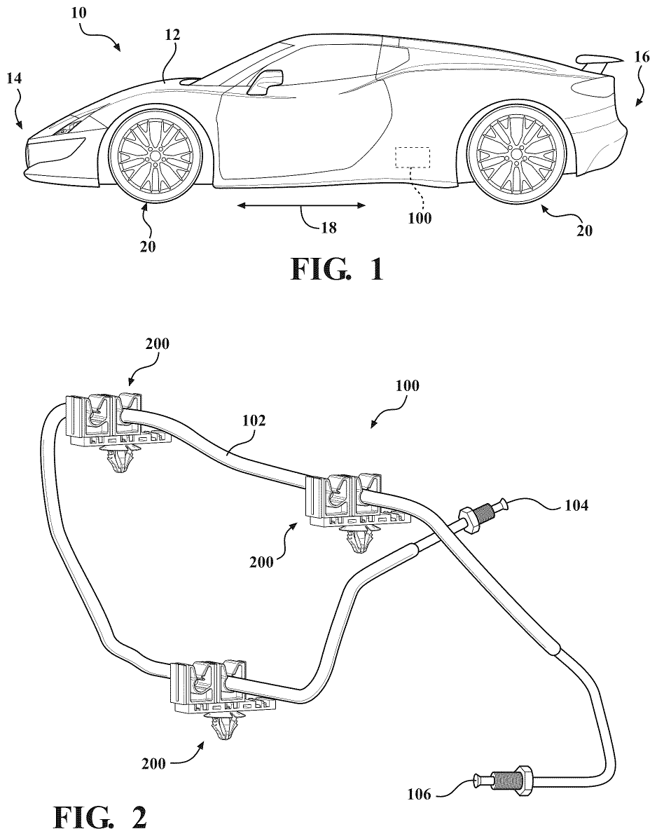

With reference to FIG. 1, an illustrative example of a vehicle 10 is provided. The vehicle 10 includes a vehicle body 12 having a first or front end 14 and a second or rear end 16 spaced from the front end 14 with respect to a longitudinal axis 18. The vehicle 10 includes one or more wheels 20 coupled to the vehicle body 12.

With reference to FIGS. 1 and 2, the vehicle 10 includes one or more conduit assemblies 100 that extend between the front end 14 and the rear end 16. The conduit assemblies 100 can include a conduit 102 that includes a first end 104 and a second end 106 spaced from the first end 104. The conduit 102 can be configured to carry a fluid (e.g., fuel, brake, hydraulic, etc.) between the first end 104 and the second end 106. The conduit 102 can also be configured to house one or more wires (e.g., a wire harness). With continued reference to FIG. 2, the conduit assemblies 100 can include one or more fastening devices 200 (hereinafter, fastening device or fastening devices) for securing the conduit 102 to a portion of the vehicle 10, such as the vehicle body 12.

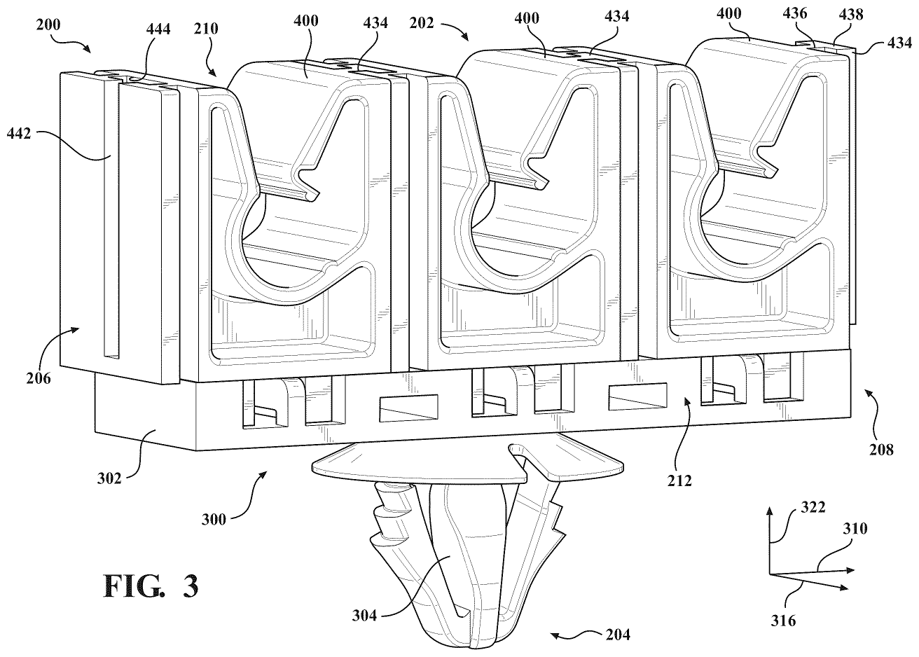

With reference to FIG. 3, an illustrative example of the fastening device 200 is provided and includes a first or upper end 202 and a second or lower end 204 spaced from the upper end 202. The fastening device 200 also includes a first or right end 206, a second or left end 208 spaced from the first end 206, a first or front side 210, and a second or rear side 212 spaced from the first side 210. The fastening device 200 includes a base 300 and one or more clips 400 arranged on or otherwise coupled to the base 300.

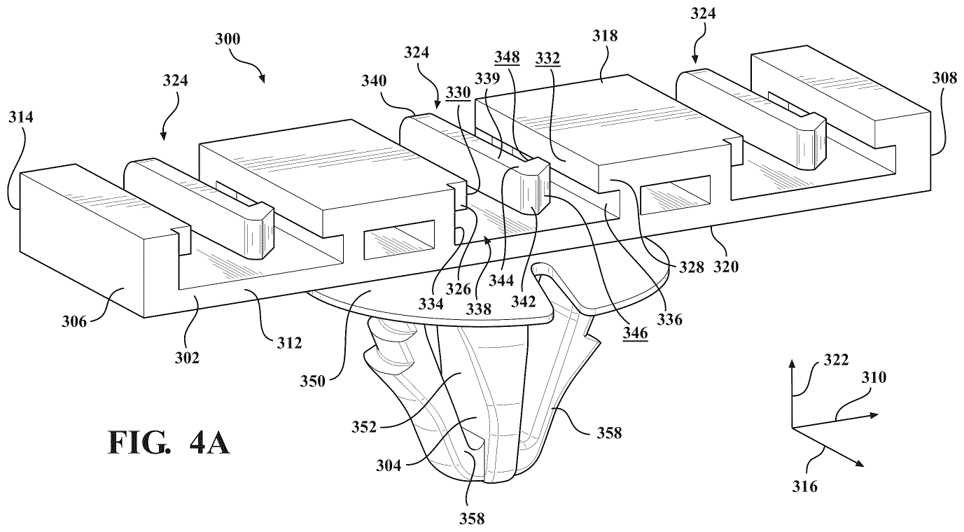

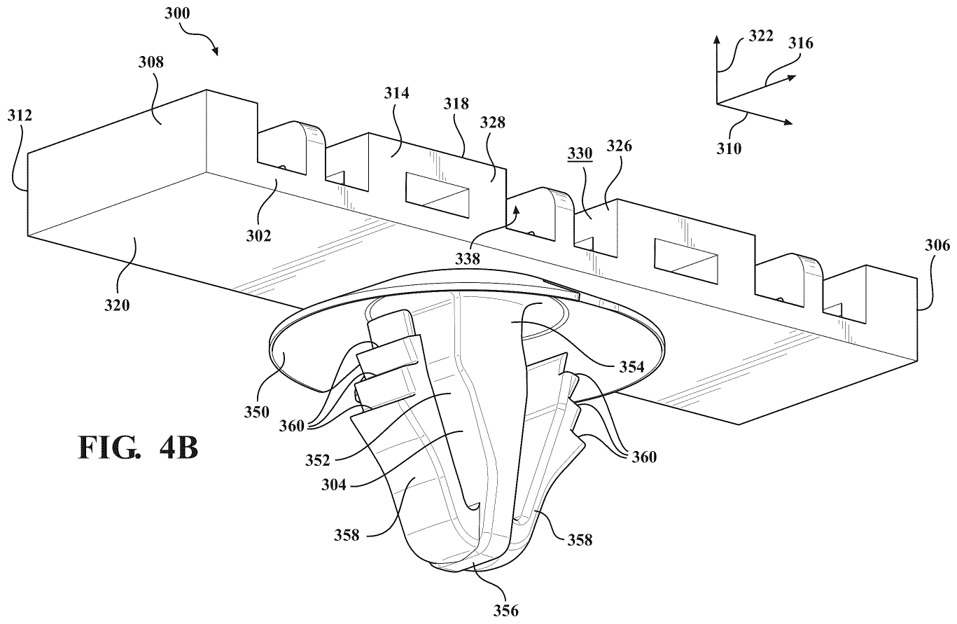

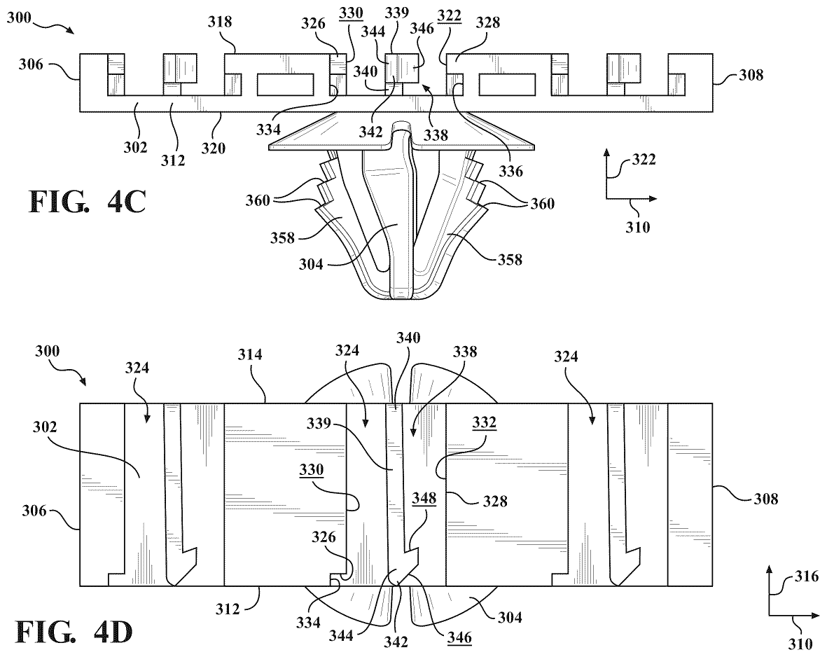

With reference to FIGS. 4A-4D, an illustrative example of the base 300 is provided. The base 300 includes a plate 302 and one or more fasteners 304 (hereinafter, fastener or fasteners) coupled to the plate 302. The plate 302 includes a first side 306 and a second side 308 spaced from the first side 306 with respect to a first axis 310. The plate 302 also includes a third side 312 extending between the first side 306 and the second side 308 and a fourth side 314 spaced from the third side 312 with respect to a second axis 316 and extending between the first side 306 and the second side 308. The first axis 310 is arranged perpendicular to the second axis 316. The plate 302 includes a top side 318 and a bottom side 320 spaced from the top side 318 with respect to a third axis 322 that is perpendicular to both the first and second axes 310, 316. One or more receptacles 324 can be arranged between the first side 306 and the second side 308 and between the top side 318 and the bottom side 320, as shown in FIG. 4C. In the present illustrative configuration, the plate 302 includes three receptacles 324, however, the number of receptacles can vary (i.e., one, two, n-number of receptacles, etc.) and the principles of the present disclosure equally apply. Each of the receptacles 324 includes a first guide 326 and a second guide 328 spaced from the first guide 326 with respect to the first axis 310. The first guide 326 includes a first surface 330 (FIG. 4B) facing the second side 308 and the second guide 328 includes a second surface 332 (FIG. 4A) opposing the first surface 330 and facing the first side 306. The first guide 326 can include a first groove 334 extending between the first surface 330 and the first side 306 with respect to the first axis 310 and between the third side 312 and the fourth side 314 with respect to the second axis 316. The second guide 328 can include a second groove 336 extending between the second surface 332 and the second side 308 and between the third side 312 and the fourth side 314 with respect to the second axis 316. The first groove 334 and the second groove 336 define an opening 338 and, as will be discussed in more detail below, can be configured to receive a portion of the one or more clips 400. The plate 302 can further include a lock arm 339 arranged in the opening 338 between the first guide 326 and the second guide 328. The lock arm 339 includes a proximal end 340 and a distal end 342 spaced from the proximal end 340. With reference to FIGS. 4C and 4D, the proximal end 340 can be arranged adjacent to the fourth side 314 and extend toward the third side 312 so that the lock arm 339 is cantilevered between the proximal end 340 and the distal end 342. The distal end 342 can include a lock 344 that includes a drive-on or tapered surface 346 and a retainer surface 348. As will be discussed in more detail below, the one or more clips 400 can be configured to contact the drive-on surface 346 and cause the lock arm 339 to flex with respect to first axis 310. As the clip 400 moves past the drive-on surface 346, the lock arm 339 can return to its original position and the retainer surface 348 can engage with and retain and/or prevent the clip 400 from being inadvertently removed from the base 300, for example.

With reference to FIGS. 4B and 4C, the fastener 304 is coupled to the bottom side 320 of the plate 302 and extends away from the plate 302 with respect to the third axis 322. In the present illustrative configuration, the base 300 includes one fastener 304, however, the number of fasteners may vary (i.e., two, three, n-number of fasteners, etc.) and the principles of the present disclosure equally apply. The fastener 304 can include a flange 350 that is coupled to and depends away from the bottom side 320 of the plate 302. The fastener 304 includes a central column 352 coupled to the flange 350 and/or the plate 302. More particularly, with reference to FIG. 4B, the central column 352 includes a proximal end 354 coupled to the flange 350 and/or the plate 302 and a distal end 356 spaced from the proximal end 354. Engagement legs 358 are coupled to the distal end 356 and extend toward the plate 302. The engagement legs 358 each include one or more steps 360 that face the bottom side 320 of the plate 302. In general, the fastener 304 can be configured to engage with and capture a substrate (e.g., a portion of the vehicle body 12) between the flange 350 and the one or more steps 360.

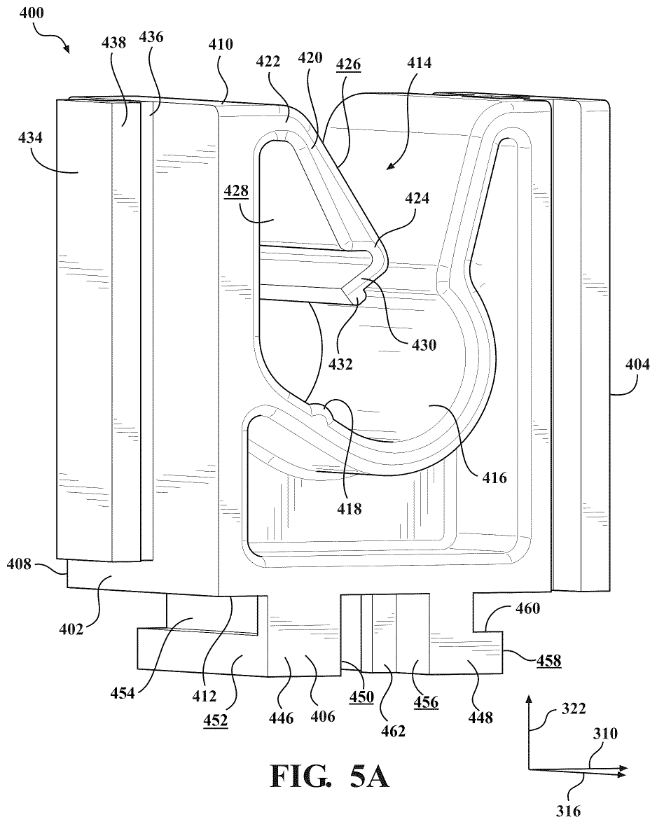

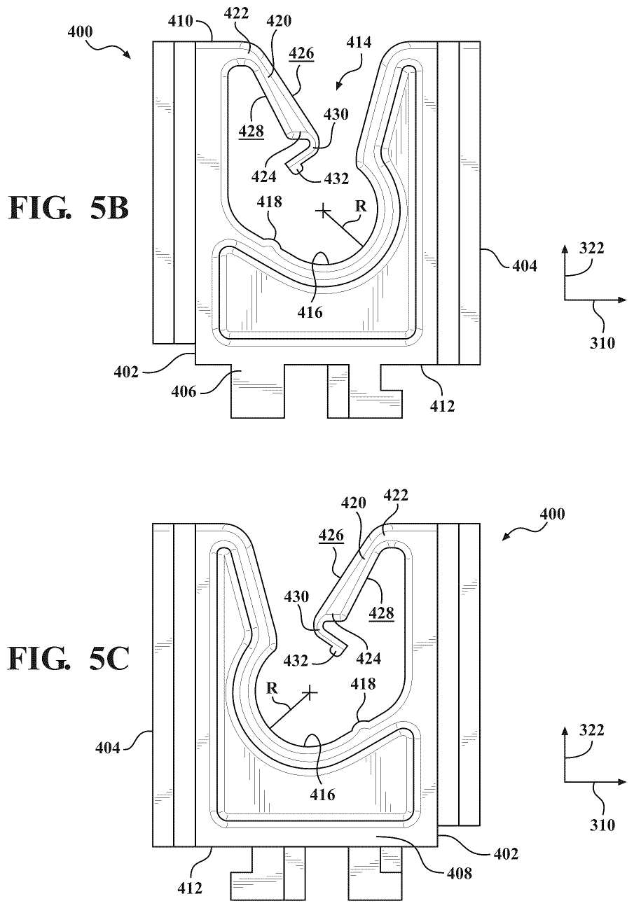

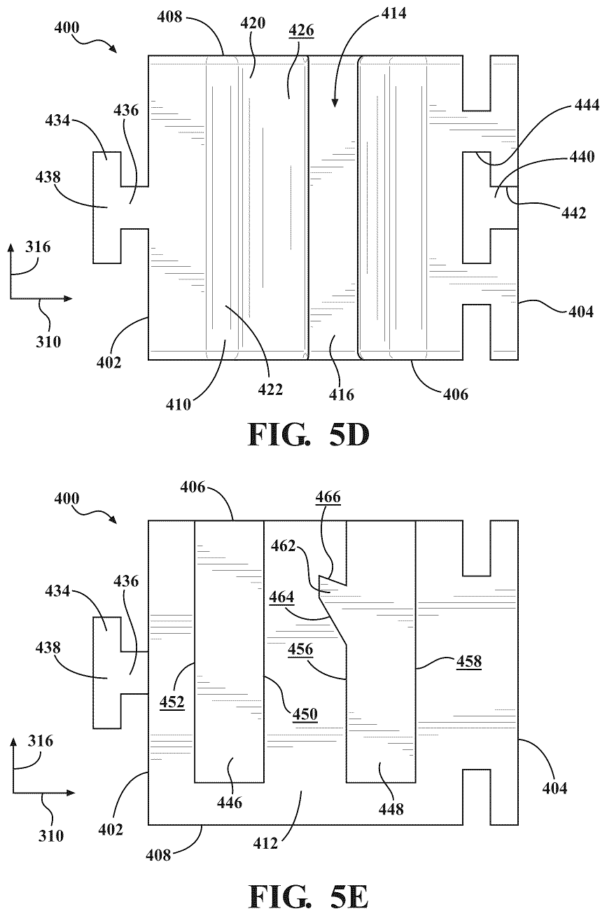

With reference to FIG. 5A, an illustrative example of the clips 400 is provided showing the clips 400 configured to receive and secure a conduit such as, a brake line, fuel line, wire harness, etc. The clips 400 include a first side 402 and a second side 404 spaced from the first side 402 with respect to the first axis 310. The clips 400 also includes a third side 406 extending between the first side 402 and the second side 404 and a fourth side 408 spaced from the third side 406 with respect to the second axis 316 and extending between the first side 402 and the second side 404. The clips 400 include a top side 410 and a bottom side 412 spaced from the top side 410 with respect to the third axis 322.

With reference to FIGS. 5A, 5B, and 5C, the clips 400 each include a cavity 414 that extends between the third side 406 and the fourth side 408 and between the top side 410 and the bottom side 412. The cavity 414 can include a slot 416 that also extends between the third side 406 and the fourth side 408. The slot 416 can be configured to receive and/or hold a portion of the conduit 102 or another component commonly used in the automotive industry. For instance, a lip 418 can extend from the slot 416 into the cavity 414 between the third side 406 and the fourth side 408. The lip 418 can be desirable for retaining a portion of the conduit 102 within the slot 416. According to one aspect, the slot 416 can have a radius that corresponds with that of the conduit 102. Note, the clip 400 can be configured to receive conduits that have a range of diameters. In other words, one of the clips 400 can be configured to receive conduits that have a diameter ranging between a first diameter and a second diameter and another one of the clips 400 can be configured to receive conduits that have a diameter ranging between a third diameter and a fourth diameter. Stated differently, one of the clips can be configured to receive a brake line, one of the clips 400 can be configured to receive a fuel line, and another one of the clips can be configured to receive a wire harness with one or more of the foregoing components having a different diameter than the other components. The clip 400 can be configured to receive other components found in the automotive industry not listed here as well.

With reference again to FIGS. 5A, 5B, and 5C, the clips 400 can include an arm 420 that extends from the top side 410 into the cavity 414 toward the bottom side 412. More particularly, the arm 420 can include a proximal end 422 coupled to and/or defining a portion of the top side 410 and a distal end 424 spaced from the proximal end 422. As will be discussed in more detail below, the arm 420 is cantilevered with respect to the cavity 414 and can flex and return to or close to its original position. The arm 420 includes an outer or engagement surface 426 and an inner surface 428 opposite the engagement surface 426. The arm 420 can further include a hand 430 coupled to and arranged at the distal end of the arm 420. The hand 430 can extend between the third side 406 and the fourth side 408 can be cantilevered with respect to the arm 420. One or more fingers 432 can be coupled to and extend from the hand 430. The hand 430 and one or more fingers 432 can engage with and help retain the conduit 102 within the cavity 414, for example.

With reference again to FIG. 3, the clips 400 can be configured to be coupled with one another. In the present illustrative example, the clips 400 are configured to be coupled with one another prior to being attached to the base 300. However, in another configuration, the clips 400 can be configured to be coupled to each other while they are being attached to the base 300 as well.

With reference to FIGS. 5A, 5D, and 5E, a tongue 434 can be coupled to or otherwise attached to the first side 402 and extend between the top side 410 and the bottom side 412. The tongue 434 can include a first segment 436 coupled to the first side 402 and a second segment 438 coupled to and arranged perpendicular to the first segment 436.

With reference to FIGS. 3 and 5D, a channel 440 can extend between the top side 410 and the bottom side 412 and can be configured to receive the tongue 434. In other words, the channel 440 includes a first opening 442 that extends through a portion of the second side 404 and between the top side 410 and the bottom side 412. The channel 440 also includes a second opening 444 that extends through the top side 410 toward the bottom side 412. The first opening 442 can be arranged perpendicular to the second opening 444. In assembly, with reference to FIG. 3, the tongue 434 of one of the clips 400 can be arranged in a channel 440 of another one of the clips 400. More particularly, the first segment 436 can slide into the first opening 442 and the second segment 438 can slide into the second opening 444 with respect to the third axis 322.

With reference to FIG. 5E, one or more rails are arranged on the bottom side 412 and are configured to correspond with and/or engage with one of the receptacles 324. The one or more rails can include a first rail 446 and a second rail 448 parallel to the first rail 446. The first and second rail 446, 448 extend between the third side 406 and the fourth side 408. The first rail 446 includes a first inner surface 450 and a first outer surface 452 opposite the first inner surface 450. The first rail 446 can further include a first track 454 that extends from the first outer surface 452 toward the second side 404 with respect to the first axis 310. The first track 454 can be configured to correspond with the first groove 334 of the receptacles 324. The second rail 448 includes a second inner surface 456 and a second outer surface 458 opposite the second inner surface 456. The second rail 448 can further include a second track 460 (FIG. 5A) that extends from the second outer surface 458 toward the first side 402 with respect to the first axis 310. The second track 460 can be configured to correspond with the second groove 336 of the receptacles 324. The second track 460 can also include a latch 462 that is coupled to the second inner surface 456 and extends toward the first inner surface 450. The latch 462 can include a first latch surface 464 facing the fourth side 408 and a second latch surface 466 facing the third side 406.

In assembly, one of the clips 400 can be coupled together as introduced above and then can be aligned with the receptacles 324 on the third side 312. In other words, the first rail 446 of each clip 400 is arranged between the first guide 326 and the lock arm 339 of one of the receptacles 324 and the second rail 448 is arranged between the second guide 328 and the lock arm 339 of the same receptacle 324. A user or a machine can advance the clips 400 with respect to the second axis 316 so that the first latch surface 464 of the clips 400 engage with the drive-on surfaces 346 of the locks 344. The lock arms 339 will flex with respect to the first axis 310 so that the latches 462 can move past the lock 344. As the latches 462 move past the lock arms 339, the lock arms 339 will gradually return to or close to their original positions and the second latch surfaces 466 will engage with the retainer surface 348. The third side 312 of the base 300 can be flush with the third side 406 of the clips 400. Additionally or alternatively, the fourth side 314 of the base 300 can be flush with the fourth side 408 of the clips 400.

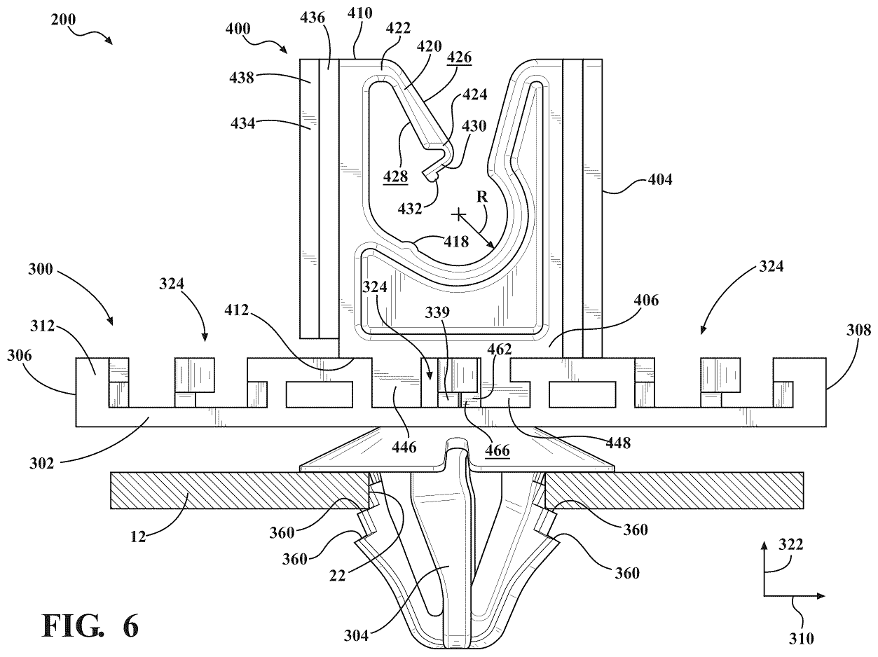

With reference to FIG. 6, the fastening device 200 can be arranged with respect to a portion of the vehicle body 12. In other words, the fastener 304 can be inserted into an opening 22 of the vehicle body 12. The engagement legs 358 will contact a portion of the opening 22 and bend inwardly with respect to the first axis 310. The portion of the vehicle body 12 can be contained between the one or more steps 360 and the flange 350. According to at least one aspect, the fastening device 200 and more particularly, the fastener 304, can be configured so that it cannot be easily removed from the vehicle body 12 without causing damage to the fastener 304.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A fastening device, comprising:
a base, comprising:
a plate, comprising:
a first side and a second side spaced from the first side with respect to a first axis,
a third side and fourth side spaced from the third side with respect to a second axis,
a top side and a bottom side spaced from the top side with respect to a third axis, the first axis, the second axis, and the third axis being perpendicular to one another, and
one or more receptacles arranged between the top side and the bottom side; and
one or more clips arranged in the one or more receptacles.

2. The fastening device of claim 1, wherein the one or more receptacles include a first guide and a second guide spaced from the first guide with respect to the first axis.

3. The fastening device of claim 2, wherein the first guide includes a first surface facing the second side and the second guide includes a second surface opposing the first surface and facing the first side.

4. The fastening device of claim 3, wherein the first guide includes a first groove extending between the first surface and the first side with respect to the first axis and between the third side and the fourth side with respect to the second axis and the second guide includes a second groove extending between the second surface and the second side and between the third side and the fourth side with respect to the second axis, the first groove and the second groove defining an opening.

5. The fastening device of claim 4, wherein the plate further includes a lock arm arranged in the opening between the first guide and the second guide.

6. The fastening device of claim 5, wherein the lock arm includes a lock that has a drive-on surface facing the third side and a retainer surface facing the fourth side.

7. The fastening device of claim 1, wherein the base further includes a fastener having a proximal end and a distal end opposite the proximal end, the proximal end is coupled to the bottom side of the plate, one or more engagement legs are coupled to the distal end and extend toward the bottom side of the plate.

8. The fastening device of claim 7, wherein the fastener includes a flange depending away from the bottom side of the plate and one or more steps arranged on the engagement legs, the one or more steps opposing the flange.

9. A fastening device, comprising:
a base, comprising:
a plate having one or more receptacles, and
a fastener coupled to the plate; and
one or more clips arranged in the one or more receptacles, the one or more clips comprising:
a first side and a second side spaced from the first side,
a third side and a fourth side spaced from the third side,
a top side and a bottom side spaced from the top side, and
a cavity that extends between the third side and the fourth side and between the top side and the bottom side.

10. The fastening device of claim 9, wherein the one or more clips include at least one first clip configured to receive a conduit with a first diameter and one or more additional clips that are configured to receive a conduit with a diameter other than the first diameter.

11. The fastening device of claim 9, wherein the one or more clips further include an arm that has a proximal end coupled to the top side and a distal end spaced from the proximal end, the distal end being arranged in the cavity.

12. The fastening device of claim 11, wherein the arm is cantilevered with respect to the cavity and includes an engagement surface extending between the proximal end and the distal end.

13. The fastening device of claim 9, wherein the one or more clips further include a first rail and a second rail coupled to the bottom side, the first rail being arranged parallel to the second rail.

14. The fastening device of claim 13, wherein the first rail includes a first inner surface and a first outer surface opposite the first inner surface, the first rail includes a first track that extends from the first outer surface toward the second side.

15. The fastening device of claim 14, wherein the second rail includes a second inner surface and a second outer surface opposite the second inner surface, the second rail includes a second track that extends from the second outer surface toward the first side, and the second rail includes a latch coupled the second inner surface and extending toward the first inner surface.

16. A vehicle, comprising:
a vehicle body having a first end and second end spaced from the first end with respect to a longitudinal axis;
at least one conduit assembly coupled to the vehicle body and extending between the first end and the second end, the at least one conduit assembly comprising:
one or more fastening devices, comprising:
a base, comprising:
a plate, comprising:
a first side and a second side spaced from the first side with respect to a first axis,
a third side and fourth side spaced from the third side with respect to a second axis,
a top side and a bottom side spaced from the top side with respect to a third axis, the first axis, the second axis, and the third axis being perpendicular to one another, and
one or more receptacles arranged between the top side and the bottom side; and
one or more clips coupled to the plate at respective ones of the one or more receptacles, the one or more clips comprising:
a first side and a second side spaced from the first side of the one or more clips with respect to the first axis,
a third side and a fourth side spaced from the third side of the one or more clips with respect to the second axis, and
a top side and a bottom side spaced from the top side of the one or more clips with respect to the third axis.

17. The vehicle of claim 16, wherein the third side of the one or more clips is arranged flush with the third side of the plate.

18. The vehicle of claim 17, wherein the fourth side of the one or more clips is arranged flush with the fourth side of the plate.

19. The vehicle of claim 16, wherein the at least one conduit assembly further includes one or more conduits of varying diameter and extending between the first end and the second end of the vehicle body, the one or more conduits being coupled to each conduit assembly.

20. The vehicle of claim 19, wherein the one or more conduits include at least one of a brake line, a fuel line, and a wire harness.
